(19) United States
(12) Patent Application Publication
(10) Pub. No.: US 2006/0136289 A1
(43) Pub. Date: Jun. 22, 2006

(54) Method for computer-supported control of production processes

(76) Inventor: Joachim Niemann, Dresden (DE)

Correspondence Address: BAKER & BOTTS, 30 ROCKEFELLER PLAZA, 44TH FLOOR, NEW YORK, NY, 10112, US

(21) Appl. No.: 10/521,640

(22) PCT Filed: Jul. 28, 2003
(86) PCT No.: PCT/DE03/02531

§ 371 Date: Aug. 17, 2005

(30) Foreign Application Priority Data
Jul. 26, 2002 (DE) 102 34 327.6

(51) Int. Cl. G06F 11/34

(52) U.S. Cl. 705/11

(57) ABSTRACT

The invention relates to a method for the computer-supported control of several production processes, overlapping in time and space, in particular construction processes. The aim of the invention is to describe a method for the computer-supported control of several production processes, overlapping in time and space, in particular construction processes, which permits a good exploitation of the capacity of a data processing unit with high flexibility. Said aim is achieved, whereby modifiable capacity descriptions are formulated in data sets for a second time in at least one further databank in a standardized data format according to capacity units (LE 1 . . . n), whereby the capacity units (LE) have at least one databank reference and the databanks in the data format according to capacity positions (LV 1 . . . n) have a relationship with the databanks in the data format according to capacity units (LE) in such a way that the data of capacity positions (LV) is bidirectionally linked thereto. Said capacity units (LE), corresponding to the progress of the capacity phases, may be altered whilst retaining the connectivity to the data of the capacity positions (LV) and the capacity descriptions (LB) may also be processed and represented in a manner based on the data format according to capacity units (LE) in the various input and output formats of the input and output units in the data processing unit (DVA).

### CROSS REFERENCE TO RELATED APPLICATIONS

This application claims the benefit of International Patent Application No. PCT/DE03/02531 filed Jul. 28, 2003, which claims priority to German Patent Application No. 2102 34 327.6 filed Jul. 26, 2002, both of which applications are hereby incorporated by reference in their entireties herein.

### FIELD OF THE INVENTION

The invention relates methods for computer control of manufacturing processes. In particular the invention relates to methods for computer control of a plurality of temporally and spatially interlocking manufacturing processes.

### BACKGROUND OF THE INVENTION

Conventionally, construction operations of any kind are divided into construction steps and described by a multitude of performance positions, each containing a representation of the performance to be carried out. These performance positions must be worked off successively as well as parallel with each other, until the respective construction step has been completed.

Since the organization of construction operations is extremely complicated, if only because of the variety of works, various attempts have been made to achieve an improvement by means of suitable software. However, it has been found that the simple imaging of a construction operation by a suitable software will not function because of the complex structure of a construction operation and the continual changes that are actually on the order of the day. Therefore, the software support has heretofore been utilized only for individual construction segments or phases of performance.

For more extensive construction operations, project control programs, whose program advance is extremely linear and requires input of detailed data, are also employed. Changes in the course of construction lead to a costly program revision in all performance positions in such programs, since even the slightest change will affect all subsequent performance positions. The reason for this lies in the rigid project control.

This means that changes in the course of construction can be realized only through manual changes in the project control, and hence the performance capacity of a data processing system cannot be utilized batch wise. See e.g., Bauprojektmanagement Terminplanung mit System für Architekten und Ingenieure, Verlag Rudolf Müller, Cologne 1994.

Another example is the so-called network planning technique. The basis of this is simulation of the planned construction operation. The network planning technique is employed for complex projects with their numerous internal and external dependencies, so that the planning of the entire course of the project can be carried out. See e.g. Modernes Projektmanagement, 6th ed., Verlag Vieweg, Brunswick/Wiesbaden, 1999.

With the network planning technique, it is possible to determine the entire course of the sequence of operations governing a construction project in advance, with consideration of all dependencies. In this rather rigidly preassigned planning, those operations which lie on the critical path are made known beforehand. At the same time, in such a planning technique, so-called buffer zones are obtained for the non-critical operations, determining those periods of time within which the non-critical operations can be shifted. This ensures that the shifting of non-critical operations will not affect the total duration of the project or any partial step.

But if an essential construction performance fails, or if it becomes necessary to shift a critical operation, there is danger that the total network planning will have to be re-worked manually, with the consequence of displacing the schedule as a whole.

So it turns out that while network planning makes possible a detailed fine planning, but on the whole represents a very rigid scheme which is difficult to handle in practice. The reason for this is to be found in that network planning technique represents a forward-oriented, comparatively rigid planning.

This manifests itself clearly in the customary forms of representation of network plans, namely the process arrow networks (activity oriented) and the process node networks. In the case of the latter, it is characteristic that for like initial and final terminals, two or more operations must be introduced for clear identification of so-called virtual processes.

In order to be able to achieve such a network planning technique with the aid of a computer-supported project management, after definition of the project aim and delimitation of the project mission the partial activities required to resolve the project and the dependencies among the several partial activities must be determined.

For that purpose, independently of the program introduced, in principle the following partial steps must be worked off in order to realize project planning and control by means of a data processing system. These are the detection of the project structure, the coordination of the project calendar, and the detection of the planning times, assignment of resources (technology, labor, finances etc.) as well as inputting the costs of the resources deployed.

By means of these inputs, a project management program can easily carry out numerous calculations and compute a detailed project plan from them. The results of this calculation may be lists of operations, time programs, cost programs, implementation plans and diagrams in the form of bar and network plans.

The detection of the data here takes place in at least one data bank using tables or input masks, which then furnish the data for calculating the project plan. In the same way, the actual data are then detected during the construction operation in this data bank.

When the project is started, the task range of the project control program shifts to the monitoring and control of the project by advancing the initial and final deadlines and verifying the performance, allocation of resources, costs actually incurred and the target-actual comparison.

It is easily seen that interferences with the established network plan, especially in the case of critical operations, will lead to considerable expenditures on revision of the network plan with the unavoidable consequence of postponing the final deadline. In particular, this leads to a considerable burdening of the data processing system with additional calculations, which always become required only after occurrence of the interference, or at least recognition of the interference. An advance calculation of the influence of possible interferences is quite impossible.

The network planning technique is used for singular manufacturing operations. Such singular manufacturing processes do indeed have strong to very strong accidental factors. For this reason, a detailed planning as provided in the network planning techniques is frequently in vain, as has already been explained.

Consideration is now being to ways of improving computer control of interelated manufacturing processes. In particular attention is directed to improving methods of computer-supported control of a plurality of temporally and spatially interlocking manufacturing processes.

### SUMMARY OF THE INVENTION

The invention provides a method for computer supported control of a plurality of temporally and spatially interlocking manufacturing processes. The inventive method provides control of the manufacturing processes on the basis of performance descriptions which may be updated over an arbitrary number of performance phases. The method may be implemented using a data processing system equipped with at least one storage unit and associated input and output units. The performance descriptions of the manufacturing processes are deposited in at least one data bank in a data format, data set by data set according to performance positions, and on the basis of this data format, the performance descriptions can be represented and processed in the input and output units in various input and output formats to provide control.

An object of the invention is to create a procedure for computer-supported control of several temporally and spatially interlocking manufacturing operations, that, with high flexibility, makes possible an advance calculation of the influence of possible interferences and permits a good utilization of the performance capacity of a data processing system.

The problem underlying the invention, in the case of a method of controlling a plurality of temporally and spatially interlocking manufacturing operations, in particular construction operations, on the basis of performance descriptions updateable over an arbitrary number of performance phases, using a data processing system equipped with at least one storage unit and associated input and output units, in which the performance descriptions are deposited in at least one data bank according to performance items, data set by data set, and on the basis of this data format, the performance descriptions are represented and processed in various input and output formats in the input and output units, is solved in that the advanceable performance descriptions are formulated a second time in at least one additional data bank in a standardized data format, data set by data set, by performance units, said performance units comprising at least one data bank reference, such as works, time, location and resource reference, operation-specifically, and the data bank stand in data format by performance position with the data banks in data format according to performance units, in such interrelationship that the data of the performance items are completely coordinated in partial quantities with an arbitrary number of performance units, and are linked to these bidirectionally, these performance units being variable according to the progress of the performance phases while retaining links with the data of the performance items, and the performance descriptions are also processable and representable on the basis of the data format according to performance units in the various input and output formats of the input and output units of the data processing system.

The performance units are preferably grouped hierarchically and are arbitrarily variable in number, the data of the performance items being completely coordinated with the altered number of performance units and linked to the latter bidirectionally.

In continuation of the invention, the content and scope of the performance units is arbitrarily variable, the data of the performance items being completely coordinated with the altered performance units and bidirectionally linked to them. Only thus can the full function of the method be guaranteed.

Furthermore, the content, scope and subdivision of the data of the performance items is variable without problems, the altered data of the performance items being completely coordinated with the existing performance units and linked to them bidirectionally.

Another embodiment of the invention provides that according to the performance phases, the performance units in subordinate claims are subdivided into partial performance units, the data of the partial performance units being completely coordinated with the performance units of the superordinate plane and bidirectionally linked with them, the scope of the partial performance units being arbitrarily variable while retaining the links with the data of the superordinate performance units.

In particular, the partial performance units are modifiable according to the performance phases in their data bank reference, such as works, time, place and resource reference.

The partial performance units can be taken over in an output format in the form of a pre-protocol, this output format being immediately imageable in the output medium.

Further, partial performance units of the pre-protocol are definable as reference quantities in the form of a target status, the partial performance units defined as reference quantities being assumable in an output format in the form of a protocol and this being imageable in the output medium.

The daily reports may advantageously be augmented within the input unit with data of the reported performances.

Finally, the partial performance units defined as reference quantities are compared by the data processing unit with the data of the reported performances in the data bank and the results documented by way of the output medium.

The partial performance units defined in the target status as reference quantities can be taken over with the data of the reported performances in an output format in the form of a check list and are imageable in the output medium, where the control lists can be supplemented within the input unit with data of actual performances.

In a further embodiment of the invention, the controlling of the performances of the executant with the aid of the target and actual status of the partial performance units takes place analytically in the data banks, the results being documentable by way of the output medium.

In particular, the results of the controlling of the target and actual status of the partial performance units of the daily reports are compared with those of the control lists.

Another special embodiment of the invention is characterized in that, by way of a data feedback from the target and actual status of the partial performance units to the items of the contractual performances, with their prices, the state of fulfillment of contractual performances and the calculable costs in each performance phase are determinable and documentable by way of the output medium.

Besides, the calculations of the fulfilled contractual performances by the executant are detectable as costs by way of the input unit, comparable by data reference to the calculable costs, and the results documentable by way of the output medium.

Finally, the results in the data banks receive a defined reference to pre-formulated measures, so that the latter can be represented in an output medium in transaction-corresponding form.

By the linkage according to the invention of an arbitrary number of performance items with an arbitrary number of hierarchically grouped performance units and the constant retention of the linkage, with the possibility of arbitrary augmentation of performance units, with new linkage required in that event, the comprehensive control of complex operations is possible. Through the invention, the effective employment of a data processing system to control manufacturing processes, in particular construction procedures, is made possible for the first time.

By the new method here presented, the accidental nature in the individual singular manufacturing processes is accepted, and the requirements on the degree of detailing in planning are limited to what is necessary and available on information.

The data-technical postulate here is that the product descriptions defined independently of each other on the one hand and the performance description on the other hand are linked, where
The definitions of the result of the manufacturing operation in the form of a location structure for the work piece, in the form of a parts list for an arbitrary prototype, such as component group, component part and single parts etc. as hierarchically structured description, and
The performance of supplying the product (i.e. the result of the manufacturing operation) is likewise provided as hierarchically structured description.

By the connection of individual elements of these two hierarchical structures in almost arbitrary form, the operations of the manufacturing process are produced. These may be formulated and expanded to a relatively arbitrary extent, and owing to the hierarchical arrangement of the reference data, they can be flexibly, quickly and, adapted in accordance with concrete requirements, continued and even defined. The list of procedures, as required, in view of the current structure of the original elements, should also be hierarchically articulated. An essential point to be considered is the separation for the first time of hierarchical structures of performance units from the hierarchical local structures, that is, the separation of product and performance.

Into these data structures, known planning and estimating data can be incorporated.

This satisfies the technical prerequisite for incorporating important planning simplification, optimization and integration of information in stochastic processes of a singular manufacturing operation.

The first phase of production planning may thus be substantially limited, unlike network planning, to the description of the result of production as available at the commencement of manufacture. Owing to the hierarchical structure of the product result, all other detailed information can be hung on this hierarchical structure, without alteration or recommencement of planning. The instantaneous key data are retained, both temporally and financially. Planning can be kept very coarse, very considerably reducing the planning outlay.

In the second step of planning, the required performances can be defined and connected to the current product/part. In so doing, the existing estimating, budget and contractual data are tied in.

Until commencement of production, therefore, a complex planning/data roster, complex but simple to prepare, integrating the existing estimating and assignments, has been created. The detailing has been carried only as far as the information has come in. Detailed information insofar as required and available, has been integrated in the coarse roster of the parts lists. In the regular case, costs, deadlines etc. have been only roughly calculated.

Essential control elements for the execution of singular manufacturing processes are the so-called “Jour fixe” (i.e., a regularly scheduled meeting day or time). On these days or times, the operations in the processes of production are discussed and fixed in detail. For these Jour fixe, all thitherto available information for the organization of the manufacturing process is presented in structured and adapted form in the so-called presentation protocol. This information is reduced to the short-term planning horizon of the Jour fixe. This provides all relevant operations with concrete binding time data. Besides rough planning, this produces a second level of short-term planning, binding by agreement on all concerned (protocol). Other information, either from the declarations or from amendments or from new discoveries which naturally make out a major portion of the Jour fixe, are integrated into the existing data structure. The knowledge or agreements recorded here are set up in the data-bank-supported protocol.

Aside from the high flexibility and integration of new operations in the existing data structure without other special outlay, the decisive advantage of this method is that the usual descriptions of the project participants can be used for their operation, thus achieving a high degree of understanding and commitment. This colloquially accurate, data-bank-technically inaccurate information is effectively and usefully employable in the existing data structure, through integration by means of protocol determinations.

With this technology, it is brought about that an existing, naturally coarse planning is detailed only to match requirements. The planning outlay is thereby reduced to what is required, and at the same time concretized for those concerned in their language. Over all, this reduces planning outlay and preserves the requisite flexible possibilities. Planning is thereby rendered timely, conclusive (recorded in the protocol), sufficiently detailed and secure (discussed with those concerned).

This planning, constantly improved automatically according to the invention, can be employed by simple means and without expense for controlling (time limits, costs, quality) in the production operation, and documented accordingly. Technically, this is done with the daily/weekly reports (or reports with freely definable patterns), control lists of all kinds, clarification lists, semi-automated postponements etc. The existing data bank permits an automated accounting without additional extra costs.

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is a schematic block diagram of an arrangement for practicing the method in accordance with principles of the present invention;

FIG. 2 is a schematic representation of the coordination of LV items with LE performance units in accordance with principles of the present invention;

FIG. 3 is a schematic illustration of the reference of the performance units (LE) to the conventional estimating and contractual data;

FIG. 4 is a schematic illustration of the reference of the performance units (LE) to conventional estimating and contractual data-schematic representation of course of work (pre-planning);

FIG. 5 is a schematic illustration of the reference a continuation of FIG. 3 (work planning);

FIG. 6 is a schematic illustration of a continuation of FIG. 4 (preparation of object performance);

FIG. 7 is a schematic illustration of a continuation of FIG. 5 (object performance); and

FIG. 8 is a schematic illustration of an example of content of performance units.

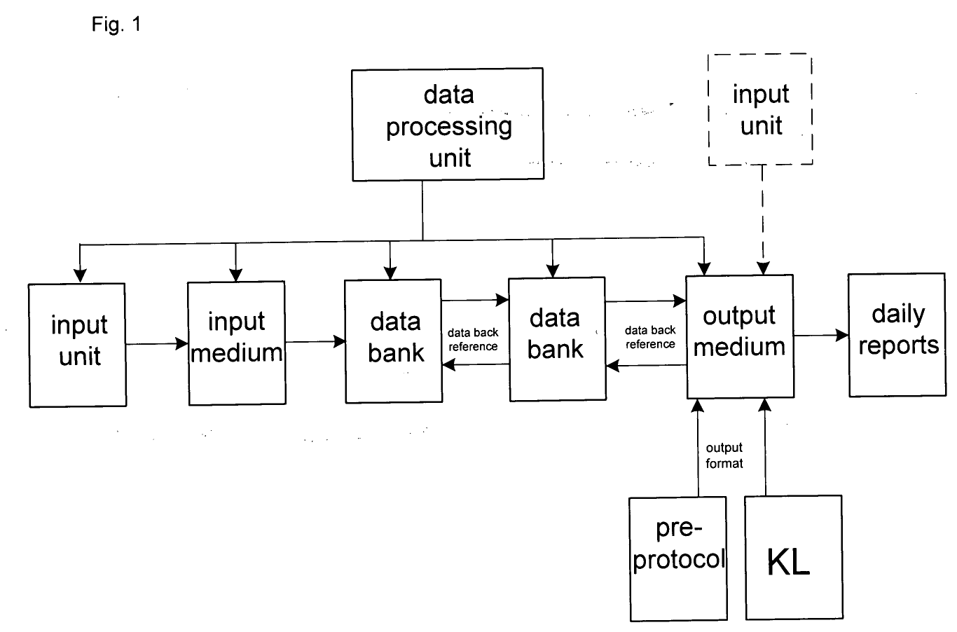

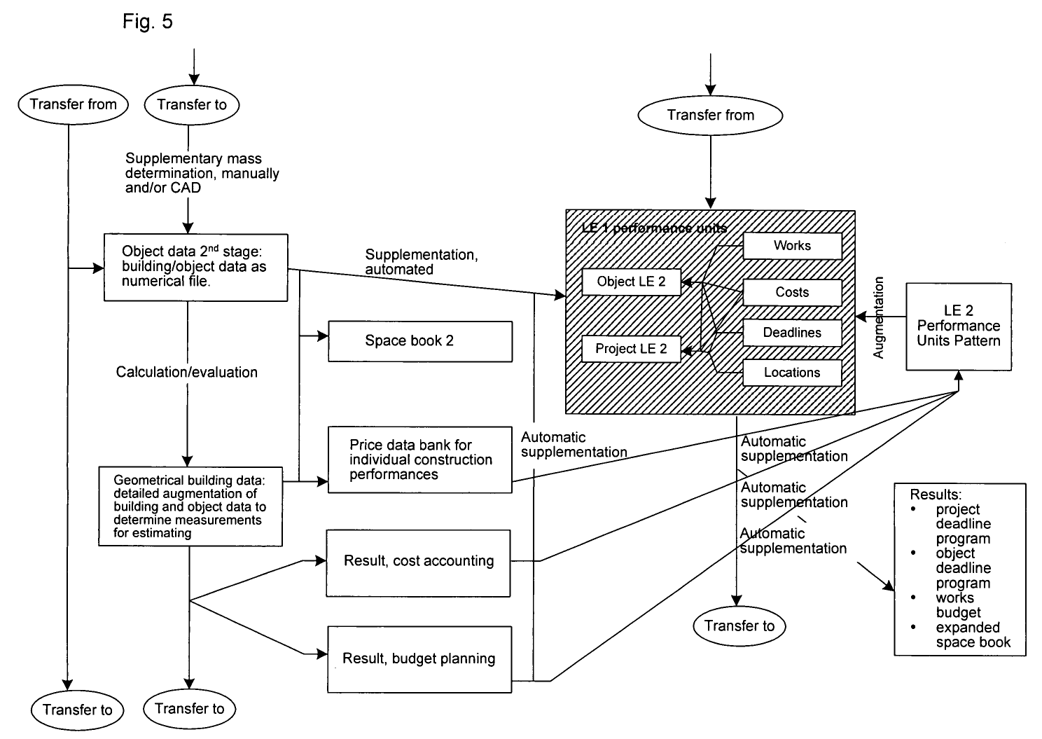

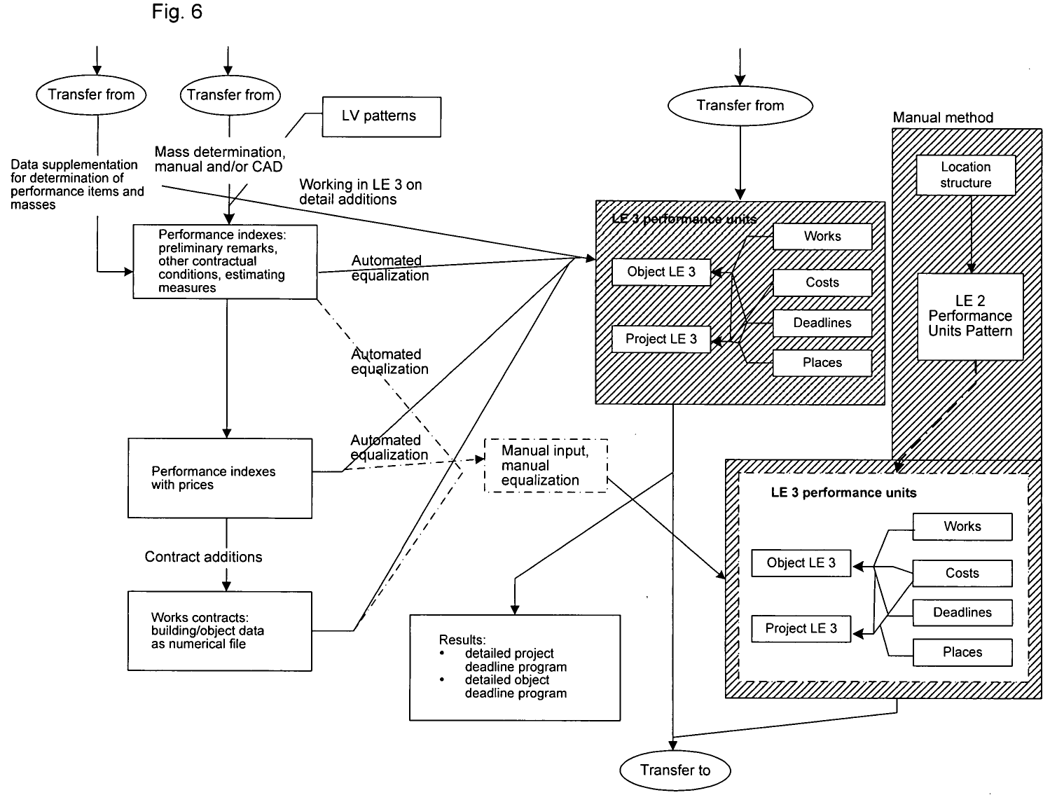

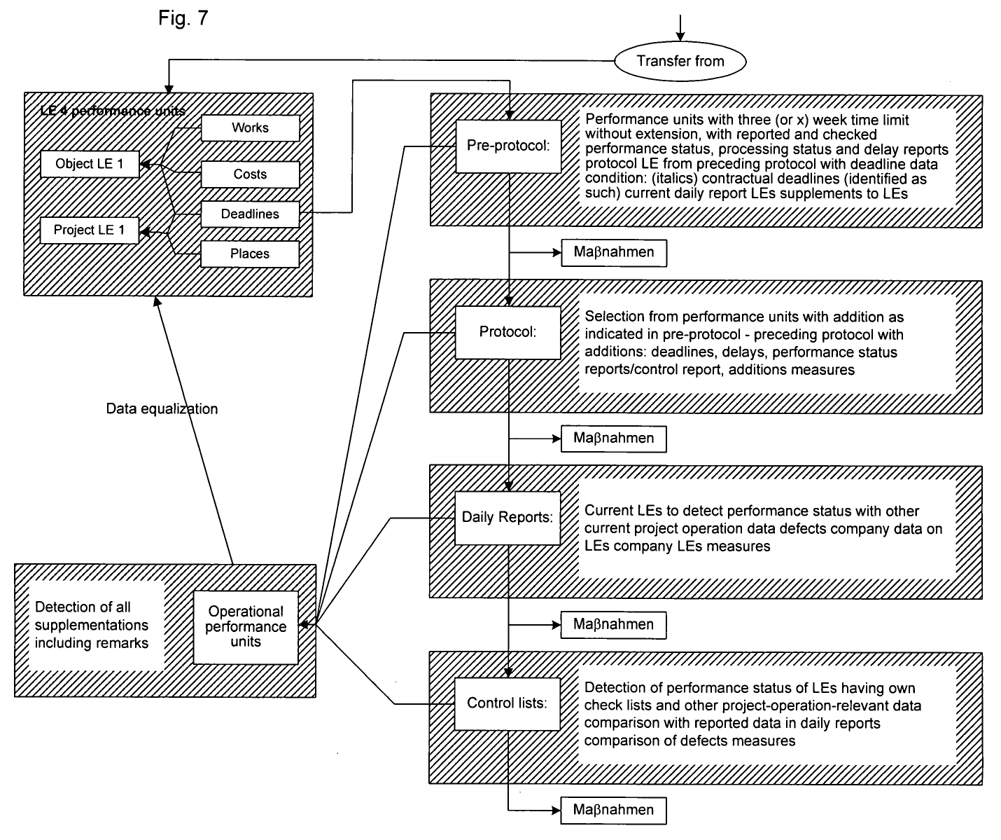

The following list is an index of the reference characters or numerals that are used in FIGS. 1-8 and in the following detailed description to refer to particular drawing elements.

List of Reference Symbols

| | |
|---|---|
| LB (1 to n) | performance unit |
| LV (1 to n) | performance item |
| TLE | partial performance unit |
| AF | output format |
| AM | output medium |
| E | input unit |
| DB | data bank |
| DRB | data bank feedback |
| LB | performance description |
| DVA | data processing system |
| VP | pre-protocol |
| TM | daily report |
| KL | control list |
| EM | input medium |

### DETAILED DESCRIPTION OF EMBODIMENTS OF THE INVENTION

The process according to the invention, which may be employed for the control of any manufacturing process, will be illustrated in more detail by an example of the control of building operations. For that purpose, first on the basis of performance descriptions updateable over an arbitrary number of performance phases, according to performance items LV (1 to n) data set by data set, in a preassigned data format, are deposited in a data bank DB.

These performance descriptions may be represented and processed on the basis of this data format in various input formats EF and output formats AF in the input media EM and output media AM.

FIG. 1 shows a schematic block diagram of an apparatus for practicing the method of computer-supported control of manufacturing processes using a data processing system DVA equipped with a storage unit in the form of a first and a second data bank DB and associated input and output media EM, AM, the input medium EM comprising an input unit E (keyboard, touch pad or the like). The data banks DB and the output medium AM (screen, printer, list) are connected to each other bidirectionally in each instance in order to provide a data feedback DRB, the output medium AM being associable with an additional input unit E (shown dotted in FIG. 1).

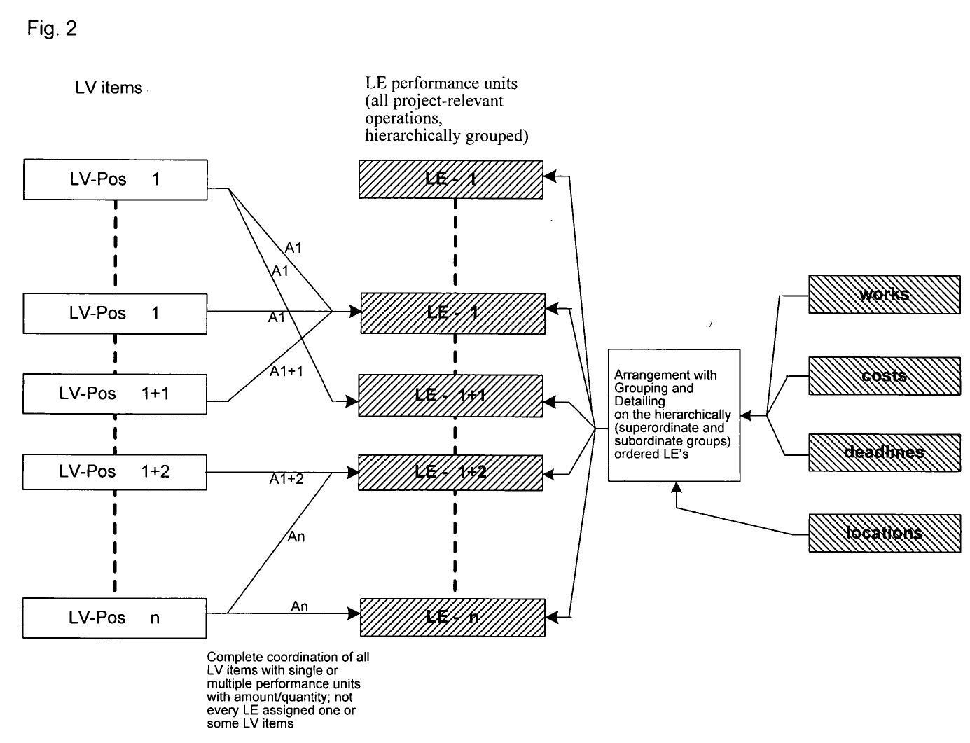

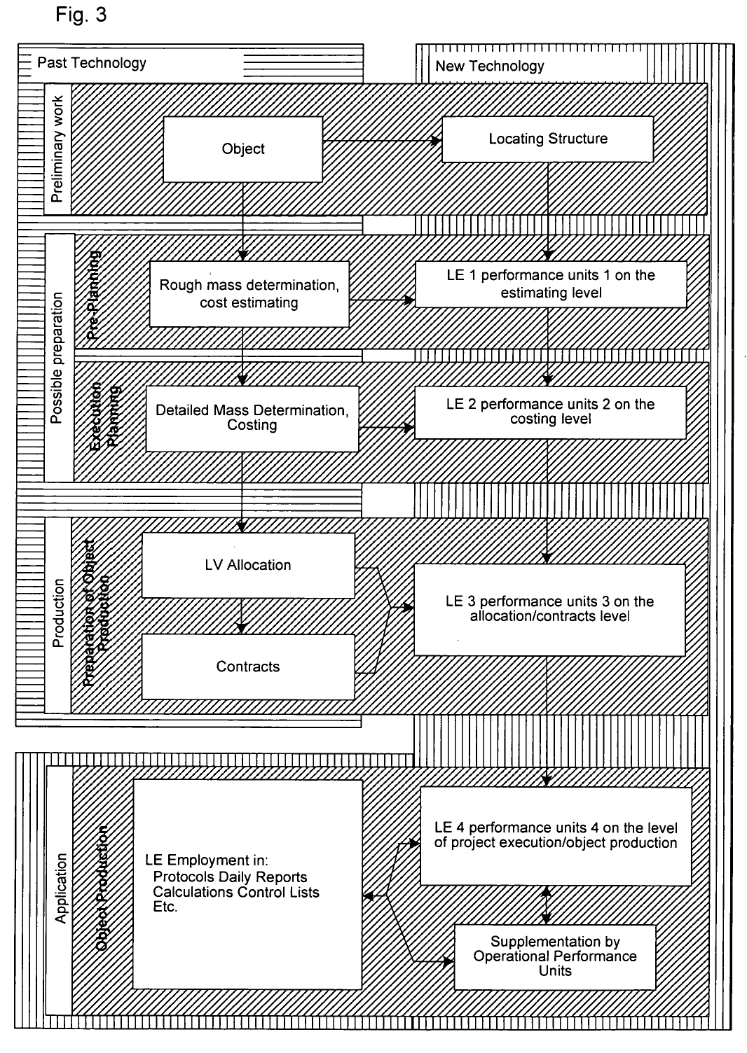

The updateable performance descriptions are then deposited, formulated data set by data set, according to performance units (LE 1 to n), the performance units LE comprising at least one data bank reference such as works, time, place or resource. The data banks DB in data format according to performance items LV (1 to n) are so interrelated with the data banks DB in data format according to performance units LE that the data of the performance items LV, subdivisible into parts of an arbitrary number of performance units LE are completely coordinated and bidirectionally linked to the latter. These performance units LE correspond to the advance of the performance phases, retaining the links with the data of the performance items LV, and are continuously variable. The performance descriptions LB are also processable and representable (FIGS. 2, 3) on the basis of the data format by performance units LE in the various input and output formats of the input and output units of the data processing system DVA.

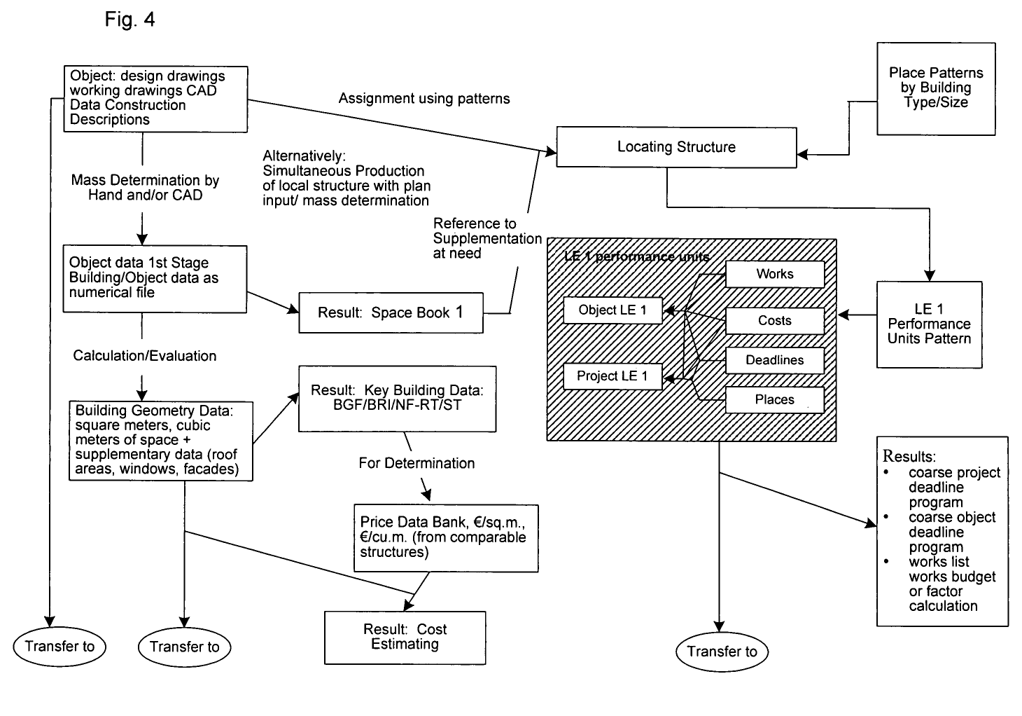

The performance units LE are hierarchically grouped and arbitrarily variable in number. A special advantage of the method according to the invention is that the content and scope of the performance units LE is arbitrarily variable, the data of the performance items LV of the altered performance units LE being completely coordinated and linked bidirectionally to the latter. A complete overview is shown in FIGS. 4 to 7.

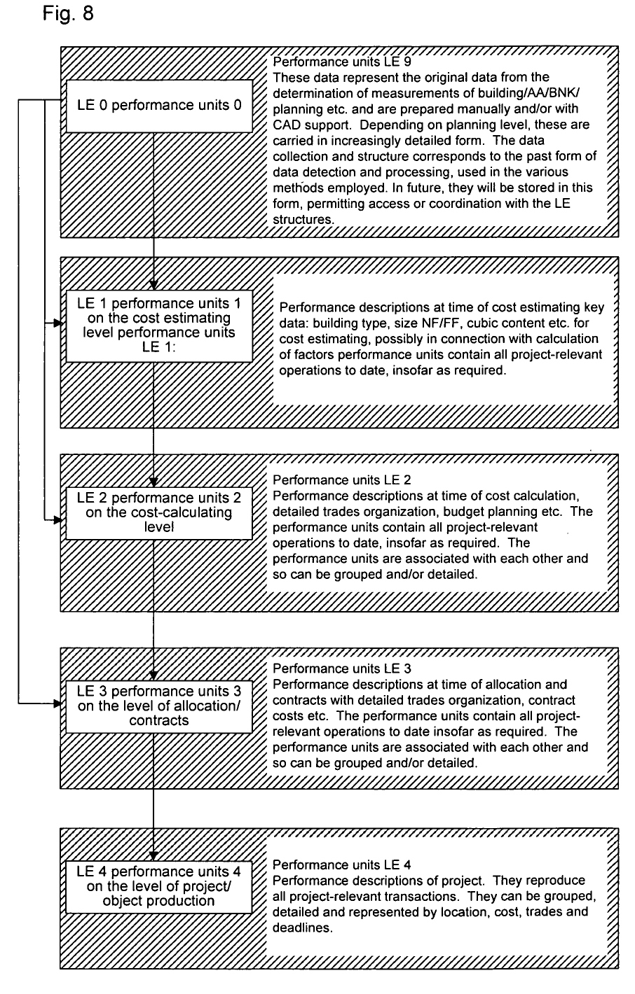

Furthermore, the content, scope and subdivision of the data of the performance units LV is divisible into partial performance units TLE (FIG. 8), the altered data of the performance items LV being completely coordinated with the existing performance units LE and linked to them bidirectionally.

The performance units LE are subdivided according to the performance phases into subordinate planes of partial performance units TLE, the partial performance units TLE being completely coordinated with the performance units LE of the superordinate plane and bidirectionally linked to them. It is essential that the content and scope of the partial performance units TLE are variable arbitrarily while retaining the links with the data of the superordinate performance units LE, the partial performance units TLE being adaptable without problems according to the performance phases in their data bank reference, such as works, time, place and resources.

The partial performance units TLE are imaged by the output medium AM in an output format AF in the form of a pre-protocol VP and imaged in the output medium AM.

In the pre-protocol VP, the partial performance units TLE are defined as reference quantities in the form of a target status. These reference quantities in the form of partial performance units TLE, defined in the target status, are taken over in the form of a protocol and imaged in the output medium AM. Further, the reference quantities in the form of partial performance units TLE defined in the target status are taken over in an output format AF in the form of a daily report TM and imaged in the output medium AM or, at need, issued as a daily report to be supplemented by way of an input unit with data on the reported performances.

Finally, the reference quantities in the form of partial performance units TLE defined in the target status are imaged together with the data of the reported performances in an output format AF in the form of a control list KL and imaged in the output medium AM.

The control lists KL are supplementable within the input unit E by data of the actual performance defined as the actual status.

A specialty of the method according to the invention is to be seen in that the controlling of the performances of the executant with the aid of the target and actual status of the partial performance units TLE takes place analytically in the control lists KL in the data banks DB, and results are documented by way of the output medium AM.

The data reference feedback DRB to be seen in FIG. 1, from the target and actual status of the partial performance units TLE to the items of their contractual performances with their prices permits a simple control of the fulfillment status of the contractual performances and the costs that can be settled at each performance phase and is documented continuously by way of the output medium AM.

The settlement for the fulfilled contractual performances of the executant are detectable by way of the input unit E or E′ as costs, comparable by data feedback DRB with the costs to be settled and the results likewise documentable by way of the output medium AM, the results in the data banks DB bearing a defined relationship to pre-formulated measures, and these being represented on the output medium AM in transaction-corresponding form.

1.-20. (canceled)

21. A method for controlling of several temporally and spatially interlocking manufacturing processes on the basis of performance descriptions which are updateable, wherein the control of the manufacturing processes can be continued over an arbitrary number of performance phases, the method comprising the steps of:
using a data processing system equipped with at least one storage unit and associated input and output units, in which the performance descriptions are deposited in at least one data bank;
depositing the performance descriptions in a data format in which data is organized data set by data set according to performance items (PV);
on the basis of this data format, representing and processing the performance descriptions in various input and output formats in the input and output units, wherein the representing and processing comprises formulating the updateable performance descriptions a second time; and
depositing the updateable performance descriptions that are formulated a second time in at least one additional data bank in a standardized data format in which data is organized data set by data set according to performance units (LE, 1 to n), wherein each performance unit (LE) comprises at least one data bank reference (such as works, time, place and resource, and production) that is in a specific interrelationship with the data banks in the data format by performance unit (LE) so that the data of the performance items (LV) are subdivisible into subsets of an arbitrary number of performance units (LE) and so that the data of the performance items (LV) are completely coordinated with said performance units (LE) and bidirectionally linked with the same, wherein the number of performance units (LE) are variable according to the progress of the performance phases with retention of the links with the data of the performance items (LV), and wherein the performance descriptions (LB) are processable and representable on the basis of the data format by performance units (LE) in the various input and output formats of the input and output units of the data processing system (DVA).

22. The method of claim 1 further comprising hierarchically grouping an arbitrarily variable number of performance units (LE), wherein the data of the performance items (LV) of an altered number of performance units (LE) are completely coordinated and linked to the latter bidirectionally.

23. The method of claim 1 wherein the content and scope of the performance units (LE) is arbitrarily variable, and wherein the data of the performance items (LV) is completely coordinated with the altered performance units (LE) and bidirectionally linked to them.

24. The method of claim 1 wherein the content, scope and subdivision of the data of the performance items (LV) is variable in partial performance units (TLE), and wherein the altered data of the performance items (LV) is completely coordinated with the existing performance units (LE) and bidirectionally linked to them.

25. The method of claim 1 wherein according to the performance phases, the performance units (LE) are divisible into subordinate planes in partial performance units (TLE), and wherein the data of the partial performance units (TLE) is completely coordinated with the performance units (LE) of the superordinate plane and bidirectionally linked to them.

26. The method of claim 24, wherein the content and scope of the partial performance units (TLE) is arbitrarily variable while retaining the links with the data of the superordinate performance units (LE).

27. The method of claim 24 wherein the partial performance units (TLE) are modifiable according to performance phases in their data bank reference (such as works, time, place and resource reference).

28. The method of claim 24 wherein the partial performance units (TLE) is adopted in an output format (AF) in the form of a pre-protocol (VP), and wherein the output format (AF) is imageable in an output medium (AM).

29. The method of claim 28 wherein the partial performance units (TLE) of the pre-protocol (VP) are defined as reference quantities in the form of a target status.

30. The method of claim 29 wherein the partial performance units (TLE) defined as reference quantities in the form of target status are taken over in an output format (AF) in the form of a protocol, and the latter is imageable in the output medium (AM).

31. The method of claim 29, wherein the partial performance units (TLE) defined as reference quantities in the form of target status are taken over in an output format (AF) in the form of daily reports (TM) and the latter are imageable in the output medium (AM).

32. The method of claim 31 wherein the daily reports (TM) are supplemented within the input unit (E) with data of the reported performances.

33. The method of claim 29 wherein the partial performance units (TLE) defined as reference quantities in form of target status are analytically comparable to the data of the reported performances in the data banks (DB) and the results are documentable by way of the output medium (AM).

34. The method of claim 29 wherein the reference quantities defining the partial performance units (TLE) in form of target status are taken over with the data of the reported performances in an output format (AF) in the form of a control list (KL) and the latter is imageable in the output medium (AM).

35. The method of claim 34 wherein the control list (KL) is supplemented within the input unit (E) with data defined as actual status of the actual performances.

36. The method of claims 34 wherein control of the performances of the executant takes place analytically by means of the target and actual status of the partial performance units (TLE) in the control lists (KL) in the data banks (DB), and wherein the results are documentable by means of the output medium (AM).

37. The method of claim 36 wherein the results of the controlling of the target and actual status of the partial performance units (TLE) of the daily reports are compared with those of the control lists (KL), and wherein the results are documentable by way of the output medium (AM).

38. The method of claim 37 wherein by way of a data feedback (DRB) from the target and actual status of the partial performance units (TLE) to the items of the contractual performances with their prices, the state of fulfillment of the contractual performances and the chargeable costs in each performance phase are determined and documented by way of the output medium (AM).

39. The method of claim 38, wherein the accountings for fulfilled contractual performances of the executants are detected as costs through the input unit (E), and compared in data feedback (DRB) with the costs to be settled, and the results are documentable by way of the output medium (AM).

40. The method of claim 21 wherein the results in the data banks (DB) bear a defined relationship to pre-formulated measures, and the latter are represented on the output medium (AM) in transaction-corresponding form.
